(19) United States
(12) Patent Application Publication
(10) Pub. No.: US 2025/0353362 A1
(43) Pub. Date: Nov. 20, 2025

(54) ROOF MODULE

(71) Applicant: YACHIYO INDUSTRY CO., LTD., Sayama-shi, Saitama (JP)

(72) Inventors: Moto KIKUCHI, Tochigi (JP); Hirotaka KAMIOKA, Tochigi (JP)

(21) Appl. No.: 18/714,255

(22) PCT Filed: Oct. 19, 2022
(86) PCT No.: PCT/JP2022/038904

§ 371 Date: Nov. 4, 2024

(30) Foreign Application Priority Data
Nov. 30, 2021 (JP) 2021-194110

(51) Int. Cl. B60J 3/02; B62D 25/06

(52) U.S. Cl. CPC B60J 3/02; B62D 25/06

(57) ABSTRACT

The roof module includes a window panel fixed to the roof, a pair of guide rails attached to an inner surface of the window panel, a shade guided by the guide rails, a drive source that actuates the shade, and a support bracket via which the drive source is attached to the window panel. The support bracket includes a bracket main body that supports the drive source, a pair of legs, and a pair of bonded parts that are joined to the window panel with an adhesive. The distance between the two legs is greater than the length of the drive source. A space longer than the length of the drive source is defined between the bracket main body and the window panel.

### TECHNICAL FIELD

The present invention relates to a roof module configured to be mounted to the roof of a vehicle.

### BACKGROUND ART

In certain vehicles, the roof thereof is provided with an opening, and a roof module is fitted to the roof so as to close the opening (Patent Document 1). The roof module includes a glass pane attached to the periphery of the opening and a shade device for selectively blocking sunlight. The shade device includes a shade member that can be extended along the inner surface of the glass pane, a guide member provided on the inner surface of the glass pane to guide the movement of the shade member, and a support brace attached to the inner surface of the glass pane to support a motor assembly (geared motor) for actuating the shade member. The support brace is bonded to the glass plate by adhesive, and the motor assembly is fixed to the support brace. Since the roof module is preassembled and attached to the roof, the roof assembly work can be greatly simplified.

### PRIOR ART DOCUMENT(S)

### Patent Document(s)

Patent Document 1: U.S. Pat. No. 6,971,704B2

### SUMMARY OF THE INVENTION

### Task to be Accomplished by the Invention

However, according to this conventional roof module, the support brace is made of a generally planar plate having an irregularly shaped cross section, and is bonded to the glass pane at upwardly projecting parts thereof by using an adhesive. Therefore, when the shade device is operated, the vibrations of the geared motor are transmitted to the glass pane so that the roof module may generate undesired noises. In particular, since the support brace contacts the glass pane at parts thereof located directly above the motor assembly or between the glass pane and the motor assembly, the vibrations of the motor assembly are transmitted to the glass pane without being attenuated so that relatively large noises may be generated.

In view of such a problem of the prior art, a primary object of the present invention to provide a roof module that can favorably reduce the generation of undesired noises.

### Means to Accomplish the Task

To achieve such an object, a certain aspect of the present invention provides a roof module (10) configured to be mounted to a roof (3) of a vehicle (1), comprising: a window panel (11) fixed to the roof; a pair of guide rails (16) attached to an inner surface of the window panel; a shade (13) guided by the guide rails along the inner surface (11a) of the window panel so as to be selectively deployed; a drive source (19) that actuates the shade; and a support bracket (18) via which the drive source is attached to the inner surface of the window panel, wherein the support bracket includes a planar bracket main body (31) extending along the inner surface of the window panel in a downwardly spaced apart relationship to the inner surface of the window panel and supporting the drive source; a pair of legs (32) extending from either opposing end of the bracket main body toward the window panel; and a pair of bonded parts (33) extending from free ends of the respective legs along the inner surface of the window panel and attached to the window panel with an adhesive (34), and wherein a distance between the legs is greater than a length of the drive source, and a space(S) longer than the length of the drive source is defined between the bracket main body and the window panel in a part of a region located between the legs and corresponding to the drive source.

Since the support bracket is attached to the inner surface of the window panel via adhesive at the two bonded parts extending along the window panel, the vibrations of the drive source generated when the shade is being operated are prevented from being directly transmitted to the window panel. Thereby, undesired noises are prevented from being emitted from the roof module. In addition, by forming a space longer than the length of the drive source between the bracket main body and the window panel, the vibrations of the drive source are attenuated while propagating through the bracket main body, and are hindered from being transmitted to the window panel by the legs so that the noises are less likely to be emitted from the window panel.

In the above aspect, it is preferable that the support bracket is a sheet metal member, and that the drive source is supported by the bracket main body via a base member (20) made of plastic material.

According to this aspect, since the drive source is supported by the plastic base member, vibrations of the drive source generated when driving the shade are attenuated while propagating through the base member. Therefore, undesired noises are less likely to occur. Furthermore, since the support bracket is a sheet metal member, peeling of the bonded parts from the window panel due to a difference in thermal expansion is suppressed.

In the above aspect, it is preferable that an opening (35) is formed in a part of the bracket main body corresponding to the drive source, and the base member is fixed to the bracket main body at opposite sides of the opening.

According to this aspect, the weight of the support bracket is reduced by forming the opening in the bracket main body. Although the rigidity of the opposite sides of the opening may be reduced due to the presence of the opening, an adequate support rigidity of the base member is ensured because the base member is fixed to the bracket main body on the opposite sides of the opening.

In the above aspect, it is preferable that a receiving opening (29) that is passed through the base member and receives a part of the drive source is formed at a position of the base member corresponding to the drive source.

According to this aspect, it is possible to reduce the thickness of the part of the roof module where the drive source is located.

In the above aspect, the roof module further includes a guide member (21) that is coupled to the shade and guides a power transmission member that transmits an output power of the drive source to the shade, and the base member is a molded member integrally molded with the guide member.

According to this aspect, displacement of the guide member is avoided when the base member to which the drive source is mounted is attached to the support bracket which is bonded to the window panel with an adhesive. Therefore, the assembly work of the roof module is facilitated.

### Effect of the Invention

According to the above aspects, the present invention provides a roof module that can suppress the generation of undesired noises.

### BRIEF DESCRIPTION OF THE DRAWINGS

FIG. 1 is a top view of a vehicle according to an embodiment of the present invention;

FIG. 2 is a perspective view of a roof module shown in FIG. 1 as viewed from inside the vehicle;

FIG. 3 is an enlarged perspective view of the mounting structure of a drive unit shown in FIG. 2;

FIG. 4 is an exploded perspective view of the mounting structure of the drive unit shown in FIG. 3;

FIG. 5 is a sectional view taken along line V-V of FIG. 1;

FIG. 6 is a view similar to FIG. 1 showing a vehicle according to a modified embodiment of the present invention; and

FIG. 7 is a sectional view taken along line VII-VII of FIG. 6.

### DETAILED DESCRIPTION OF THE PREFERRED EMBODIMENT(S)

A preferred embodiment of the present invention will be described in the following with reference to the appended drawings. In the following description, the longitudinal and lateral directions will be defined with respect to the vehicle body to which the present invention is applied.

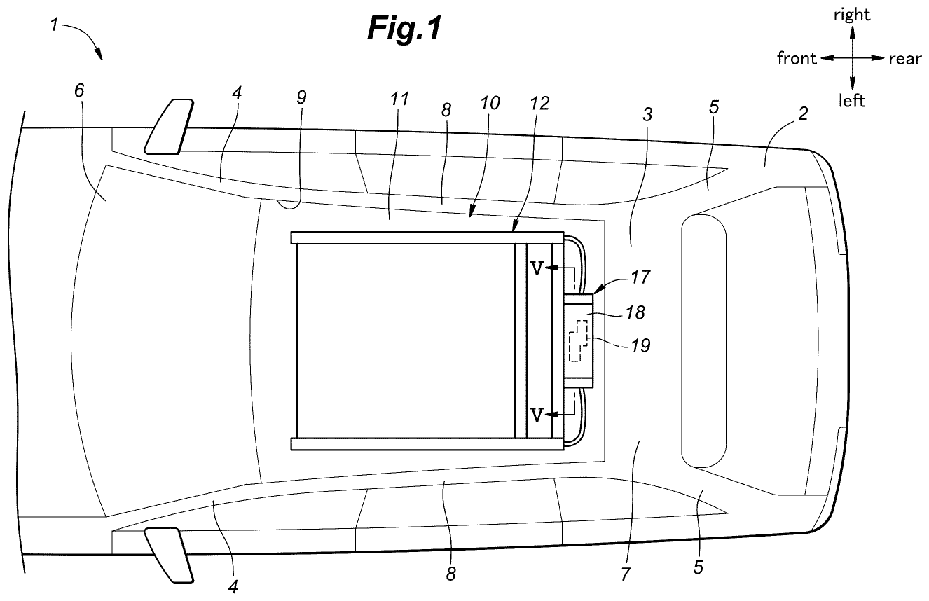

FIG. 1 is a top view of an automobile 1 according to the embodiment of the present invention. As shown in FIG. 1, the automobile 1 is provided with a vehicle body 2 that includes a roof 3, and a pair of front pillars 4 and a pair of rear pillars 5 supporting the roof 3. A windshield 6 is fitted to an opening of the vehicle body defined by the roof 3 and the front pillars 4. The roof 3 includes a roof panel 7 made of sheet steel and a pair of roof side rails 8 made of sheet steel. A front part of the roof 3 is formed with an opening 9 which is fitted with a roof module 10 so as to close the opening 9.

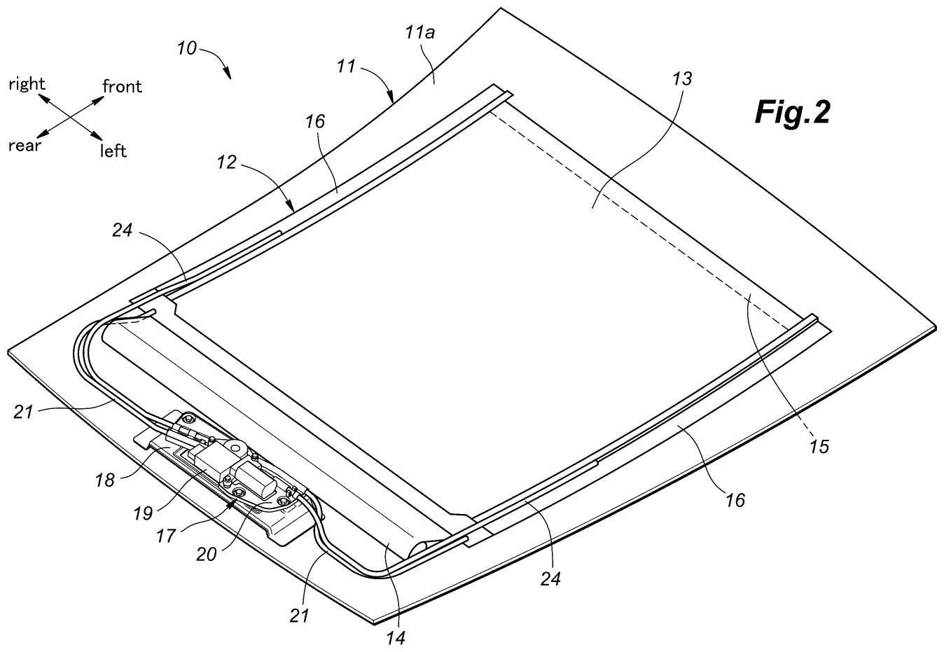

FIG. 2 is a perspective view showing the roof module 10 from below. As shown in FIGS. 1 and 2, the roof module 10 includes a window panel 11 that is fixed to the roof 3 and closes the opening 9 and a shade device 12 provided on the inner surface 11a of the window panel 11. The window panel 11 consists of a transparent or translucent grazing typically made of glass sheet that functions as a skylight to permit external light to reach the cabin from above. The outer peripheral edge of the inner surface 11a of the window panel 11 is coated with black frit (black enamel) to prevent transmission of light through the peripheral edge of the window panel 11.

The shade device 12 is configured to selectively block sunlight from passing through the transparent or semi-transparent part of the window panel 11. The shade device 12 includes a shade 13 that can be selectively deployed along the inner surface 11a of the window panel 11. In this embodiment, the shade 13 consists of a roll shade made of a flexible cloth sheet. The shade 13 can be in a retracted state in which the shade 13 is wound on a winding shaft 14 extending laterally at a rear part of the window panel 11 and a deployed state (the illustrated state) in which the shade 13 is pulled out from the winding shaft 14 to substantially cover the window panel 11 from below. The winding shaft 14 is normally urged in the winding direction by a retractor. The front edge of the shade 13 is provided with a cross bar 15 extending laterally and made of a rigid member.

A pair of guide rails 16 extending in the fore and aft direction are attached to either side edge of the inner surface 11a of the window panel 11. The two guide rails 16 are symmetric to each other and are each slightly curved so as to face the convex side thereof upward. The guide rails 16 are configured to guide the side edges of the cross bar 15 and the shade 13 along the inner surface 11a of the window panel 11. The guide rails 16 may each consist of, for example, an extruded aluminum bar.

A drive unit 17 for driving the shade 13 is attached to a laterally middle part of the rear edge of the window panel 11 from inside. The drive unit 17 is attached to the window panel 11 via a support bracket 18 fixedly secured to the inner surface 11a of the window panel 11. The drive unit 17 includes a drive source 19, a base member 20 that supports the drive source 19, and a pair of guide members 21 attached to the base member 20 and extending laterally away from the base member 20 on either side.

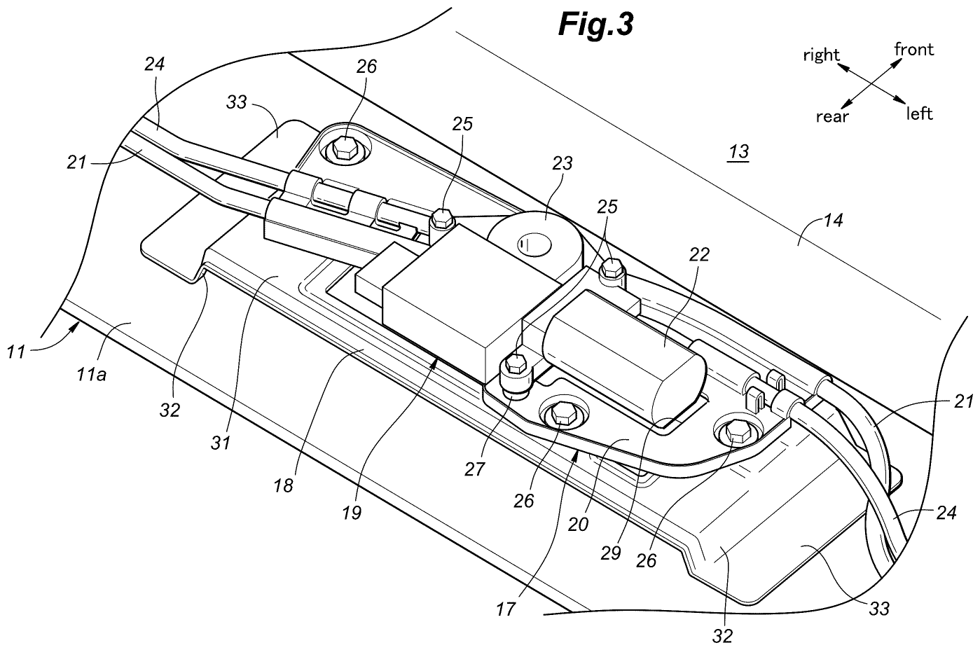

FIG. 3 is an enlarged perspective view of the mounting structure for the drive unit 17 shown in FIG. 2. As shown in FIGS. 2 and 3, the drive source 19 is formed by a geared motor that includes an electric motor 22 and a gear case 23 that accommodates a gear train connected to the output shaft of the electric motor 22. The electric motor 22 is attached to the gear case 23 with the output shaft thereof extending laterally. The drive source 19 is provided with an output gear consisting of a pinion projecting upward from the upper surface of the gear case 23.

The pinion of the drive source 19 is connected to the shade 13 via a pair of push-pull cables extending on either side to serve as power transmission member. Each push-pull cable is connected to a corresponding end of the cross bar 15 at one end thereof and meshes with the pinion of the drive shaft at an intermediate part thereof. The part of each push-pull cable extending from the one end to the part thereof meshing with the pinion forms a drive part that is effective in transmitting the power of the drive source 19 to the shade 13. The part of each push-pull cable extending from the part thereof meshing with the pinion to the other end forms an idle part that does not transmit power from the drive source 19.

The drive part of each push-pull cable is guided by a guide member 21 having high rigidity. The guide member 21 may consist of a steel pipe having a circular cross section, and connects the base member 20 to the corresponding guide rail 16. The idle part of each push-pull cable is covered by a cover member 24 having low rigidity. The cover members 24 may each consist of a resin pipe having a circular cross section, and extends from the base member 20 along the guide member 21 of the opposite side.

The base member 20 consists of an injection molded plastic member, and is integrally joined to the guide members 21 by out-sert molding. In other words, the base member 20 consists of an integrally molded product integrally molded with the guide members 21. Thereby, the guide members 21 are firmly fixed to the base member 20. The base member 20 may be formed with grooves for receiving the cover members 24 and clip members for detachably retaining the cover members 24 in the grooves. The cover members 24 are thereby slightly movably attached to the base member 20, but are firmly fixed to the corresponding guide members 21 by cable ties. The drive unit 17, the cover members 24 and the push-pull cables are assembled to the base member 20, and the base member 20 is then attached to the support bracket 18 in mounting the entire assembly to the window panel 11.

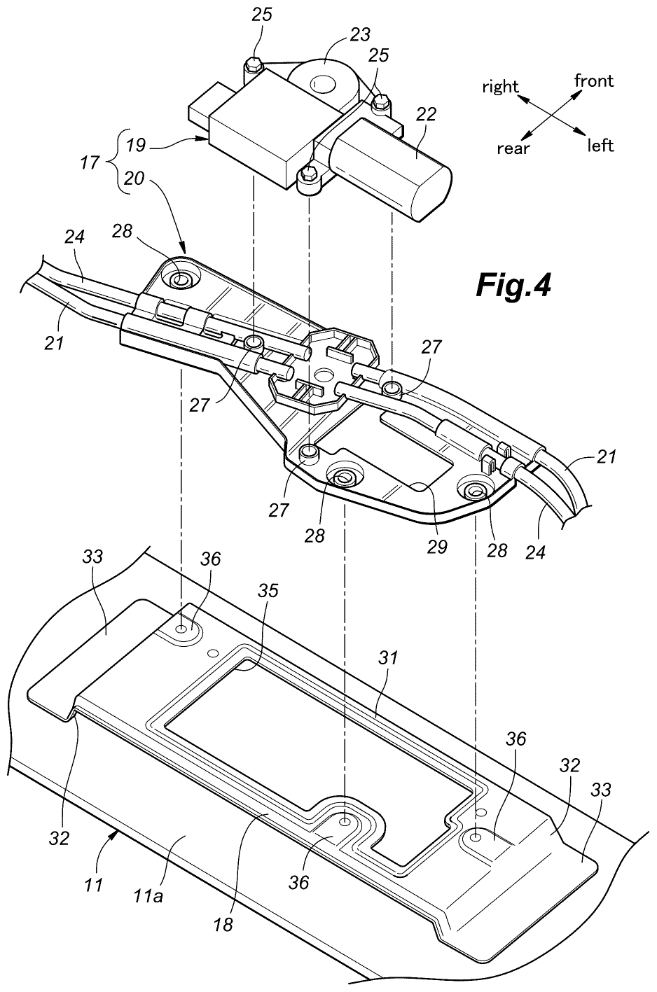

FIG. 4 is an exploded perspective view of the mounting structure of the drive unit 17 shown in FIG. 3. As shown in FIGS. 3 and 4, the drive source 19 is attached to the base member 20 with a plurality of first fasteners 25. In this embodiment, the drive source 19 is attached to the base member 20 with three bolts. Alternatively, the first fasteners 25 may consist of screws, clips, rivets, etc., and two, four or more of the first fasteners 25 may be used.

Similarly, the base member 20 is attached to the support bracket 18 with a plurality of second fasteners 26 (FIG. 3). In this embodiment, the base member 20 is attached to the support bracket 18 with three bolts. Alternatively, the second fasteners 26 may consist of screws, clips, rivets, etc., and two, four or more of the second fasteners 26 may be used.

As shown in FIG. 4, the base member 20 is provided with three first fastening portions 27 for fastening the first fasteners 25 and three fastening holes 28 for passing through the second fasteners 26. Furthermore, a receiving opening 29 for receiving a part of the electric motor 22 is formed in the base member 20 at a position corresponding to the electric motor 22. The receiving opening 29 is passed through the base member 20.

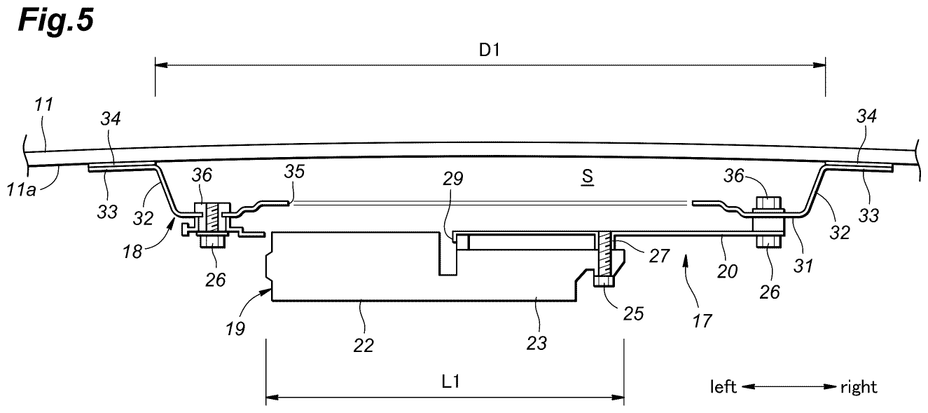

The support bracket 18 consists of a stamp-formed sheet metal member, and has a substantially planar bracket main body 31, a pair of legs 32 and a pair of bonded parts 33. The bracket main body 31 has a rectangular outer contour that is elongated in the lateral direction, and extends along the inner surface 11a of the window panel 11 at a position spaced downward from the window panel 11. The drive source 19 is thus supported by the support bracket 18 via the base member 20. The legs 32 extend toward the window panel 11 from the respective lateral ends of the bracket main body 31, and the bonded parts 33 extends from the free ends of the legs 32, respectively, away from each other. The bonded parts 33 each have a planar plate shape and are attached to the window panel 11 with an adhesive 34 (see FIG. 5).

The bracket main body 31 is formed with a substantially rectangular opening 35 and three fastening portions 36. The fastening portions 36 are configured to fasten the corresponding second fastening members 26 for securing the base member 20 to the bracket main body 31. In this embodiment, each fastening portion 36 consists of a pedestal formed as a slightly raised part defining a pedestal surface by stamp forming, a bolt hole passed centrally through the pedestal and a welded nut fixed to the reverse surface of the pedestal opposite to the pedestal surface.

The two of the fastening portions 36 are located at the respective lateral ends of the bracket main body 31 or on the opposite sides of the opening 35, and the remaining fastening portion 36 is positioned in a part of the bracket main body 31 located along a laterally intermediate part of the opening or on one of a pair of strips extending laterally and defining the corresponding edges of the opening 35. Thus, the base member 20 is fixed to the bracket main body 31 on the laterally opposite ends of the opening 35 and a part on a long side of the opening 35.

FIG. 5 is a sectional view taken along line V-V of FIG. 1, and shows a cross section of the mounting structure for the drive unit 17 shown in FIG. 3. As shown in FIG. 5, the legs 32 and the bonded parts 33 of the support bracket 18 are symmetrically positioned. The bonded parts 33 extend from the free ends of the respective legs 32 along the inner surface 11a of the window panel 11 away from each other. The bonded parts 33 are bonded to the window panel 11 by applying an adhesive 34 substantially over the entire surface thereof.

The bracket main body 31 is thus attached to the window panel 11 only at the legs 32 thereof. In other words, the bracket main body 31 is spanned between the legs 32, and there is no support member between the legs 32 that connects the bracket main body 31 to the window panel 11. Therefore, a space S is defined between the legs 32 and between the bracket main body 31 and the window panel 11. The drive source 19 has a length L1 as measured in the lateral direction or along the direction in which the two legs 32 are arranged. The distance D1 between the legs 32 is greater than the length L1 of the drive source 19 in the lateral direction. In other words, the space S is longer than the length L1 of the drive source 19 in the lateral direction so as to accommodate the drive source 19 laterally therein.

Next, the effect of the roof module 10 configured as described above will be discussed in the following. As shown in FIG. 2, when the drive source 19 is activated, the left and right push-pull cables connected to the cross bar 15 are driven by the output pinion of the drive source 19 in the deployment direction or the storage direction. As a result, the shade 13 is pulled out from the winding shaft 14 and deployed, or is wound around the winding shaft 14 and stored. As shown in FIGS. 3 and 4, when the drive source 19 is activated, that is, when the shade device 12 is driven, the electric motor 22 and the gear train of the drive source 19 as well as the meshing parts between the pinion of the drive source 19 and the push-pull cables generate vibrations. The drive source 19 is attached to the window panel 11. Therefore, there is a possibility that the window panel 11 may generate undesired noises due to the vibrations propagating to the window panel 11.

In this embodiment, as shown in FIG. 5, the support bracket 18 is attached to the window panel 11 at the two bonded parts 33 contacting the inner surface 11a of the window panel 11 along the surface thereof via an adhesive 34. Therefore, vibrations of the drive source 19 generated when the shade 13 is driven are not directly transmitted to the window panel 11. Therefore, generation of undesired noises from the roof module 10 is minimized.

Further, the distance D1 between the two legs 32 is greater than the length L1 of the drive source 19 as measured in the lateral direction, and a space S longer than the length L1 of the drive source 19 is defined between the bracket main body 31 and the window panel 11 in a part of a region located between the legs 32 and corresponding to the drive source 19. Therefore, the vibrations of the drive source 19 are attenuated while propagating through the bracket main body 31, and are hindered from being transmitted to the window panel 11 by the legs 32 so that the noises are less likely to be emitted from the window panel.

As shown in FIGS. 3 and 4, in this embodiment, the support bracket 18 is made of sheet metal, and the drive source 19 is supported by the bracket main body 31 via the base member 20 made of plastic. Therefore, vibrations of the drive source 19 generated when driving the shade 13 are attenuated while propagating through the base member 20. Therefore, undesired noises are less likely to be transmitted to the cabin. Moreover, since the support bracket 18 is made of sheet metal, the bonded parts 33 are prevented from peeling off the window panel 11 due to a difference in thermal expansion.

The opening 35 of the bracket main body 31 is positioned so as to correspond to the drive source 19. Therefore, the weight of the support bracket 18 is reduced. Even though the parts of the support bracket 18 extending along the sides of the opening 35 may be reduced owing to the presence of the large opening 35 in the support bracket 18, since the base member 20 spans laterally across the opening 35 and is joined to the support bracket 18 at the lateral ends thereof, an adequate support rigidity of the support bracket 18 is ensured.

The base member 20 is formed with the receiving opening 29 that is passed through the base member 20 at a position corresponding to the drive source 19 so as to receive a part of the drive source 19 therein. Therefore, an increase in the vertical dimension the part of the roof module 10 where the drive source 19 is provided is avoided.

The base member 20 consists of an integrally molded plastic product, and the guide members 21 that guide the push-pull cables are integrally molded thereto. Therefore, when attaching the base member 20 on which the drive source 19 is mounted in advance to the support bracket 18 which is bonded to the window panel 11 with the adhesive 34, the displacement of the guide member 21 relative to the base member 20 is minimized. Therefore, the assembly work of the roof module 10 is facilitated.

The present invention has been described in terms of a specific embodiment, but is not limited by this embodiment and can be modified in various ways without departing from the scope of the present invention. For instance, the present application can be applied not only to the roof 3 of an automobile 1 but also to the roofs of other vehicles such as railroad cars, tram cars and trailers.

The shade 13 is not limited to a flexible roll shade such as the one used in the illustrated embodiment, but may also consist of a plurality of shade boards which can be retracted into a mutually overlapping state and deployed into an extended state.

The drive unit 17 is not required to be positioned in a rear part of the window panel 11 but may also be positioned in a front part of the window panel 11. It is also possible to cause the shade to be deployed and retracted in the lateral direction and position the drive unit 17 in a side part of the window panel 11.

The mechanism for driving the shade 13 is not limited to push-pull cables, but may also consist of rack belts or a wire in a continuous loop.

The outer profile of the bracket main body 31 of the support bracket 18 is not required to be rectangular, but may also be trapezoidal, parallelopiped, circular, elliptic of track shaped, or the like. The bonded parts 33 may also extend from the free ends of the respect legs 32 toward each other or in the same direction, instead of away from each other.

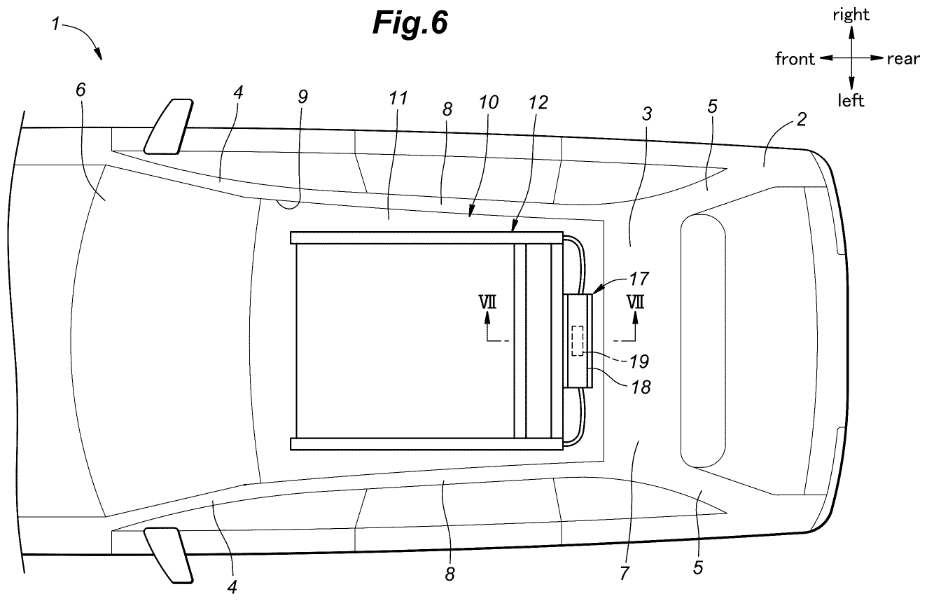

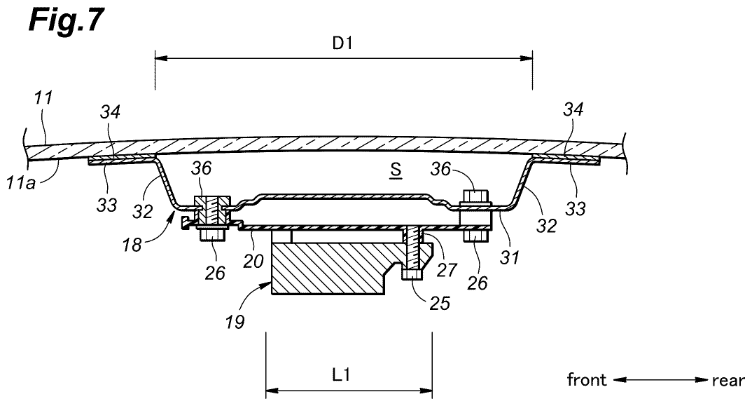

The legs 32 of the support bracket 18 are not necessarily required to be provided at either lateral end of the bracket main body 31. FIG. 6 is a top view of an automobile 1 according the modified embodiment of the present invention, and FIG. 7 is a sectional view taken along line VII-VII of FIG. 6. In this modified embodiment, a pair of legs 32 extend from two ends the bracket main body 31 arranged along the short sides of the bracket main body 31 or from either fore and aft edge of the bracket main body 31 toward the window panel 11. A space S is defined between the legs 32, and between the bracket main body 31 and the window panel 11. The drive source 19 has a length L1 along the direction in which the two legs 32 are arranged (along the fore and aft direction). The distance D1 between the two legs 32 is greater than the length L1 of the drive source 19 in the fore and aft direction. In other words, the space S is formed to be longer than the length L1 of the drive source 19 in the fore and aft direction. In this embodiment also, since a space S longer in the fore and aft direction than the length L1 of the drive source 19 between the bracket main body 31 and the window panel 11, the vibrations of the drive source are not likely to be transmitted to the window panel 11, and generation of noises from the window panel 11 can be minimized.

In addition, the specific configuration, arrangement, quantity, material, angle, etc. of each member or portion can be changed as appropriate without departing from the scope of the present invention. Moreover, not all of the constituent elements shown in the above embodiments are essential to the broad concept of the present invention, and they can be appropriately selected.

### LIST OF REFERENCE NUMERALS

| | |
|---|---|
| 1: automobile | 3: roof |
| 10: roof module | 11: window panel |
| 11a: inner surface | 12: shade device |
| 13: shade | 14: winding shaft |
| 16: guide rails | 17: drive unit |
| 18: support bracket | 19: drive source |
| 20: base member | 21: guide member |
| 29: receiving opening | 31: bracket main body |
| 33: bonded part | 34: adhesive |
| 35: opening | D1: distance between two legs 32 |
| L1: length of geared motor | |

1. A roof module configured to be mounted to a roof of a vehicle, the roof module comprising:
a window panel configured to be fixed to the roof;
a pair of guide rails attached to an inner surface of the window panel;
a shade guided by the guide rails along the inner surface of the window panel so as to be selectively deployed;
a drive source that actuates the shade; and
a support bracket via which the drive source is attached to the inner surface of the window panel,
wherein the support bracket is a sheet metal member including a planar bracket main body extending along the inner surface of the window panel in a downwardly spaced apart relationship to the inner surface of the window panel and supporting the drive source; a pair of legs extending from either opposing end of the bracket main body toward the window panel; and a pair of bonded parts extending from free ends of the respective legs along the inner surface of the window panel and attached to the window panel with an adhesive,
wherein a distance between the legs is greater than a length of the drive source, and a space longer than the length of the drive source is defined between the bracket main body and the window panel in a part of a region located between the legs and corresponding to the drive source; and
wherein the drive source is supported on a side of the bracket main body facing away from the window panel via a base member made of plastic material.

2. (canceled)

3. The roof module according to claim 1, wherein an opening is formed in a part of the bracket main body corresponding to the drive source, and the base member is fixed to the bracket main body at opposite sides of the opening.

4. The roof module according to claim 3, wherein a receiving opening that is passed through the base member and receives a part of the drive source is formed at a position of the base member corresponding to the drive source.

5. The roof module according to claim 1, further comprising a guide member that is coupled to the shade and guides a power transmission member that transmits an output power of the drive source to the shade, and the base member is a molded member integrally molded with the guide member.
